(19) United States
(12) Patent Application Publication
(10) Pub. No.: US 2014/0000397 A1
(43) Pub. Date: Jan. 2, 2014

(54) CONSTANT TO VARIABLE GEAR PITCH FOR TEMPERATURE DOOR ROTATION

(71) Applicant: VISTEON GLOBAL TECHNOLOGIES, INC., Van Buren Twp., MI (US)

(72) Inventor: Jim Patrick Nolta, JR., Canton, MI (US)

(73) Assignee: VISTEON GLOBAL TECHNOLOGIES, INC., Van Buren Twp., MI (US)

(21) Appl. No.: 13/803,699

(22) Filed: Mar. 14, 2013

Related U.S. Application Data
(60) Provisional application No. 61/666,292, filed on Jun. 29, 2012.

(51) Int. Cl. F16H 35/02

(52) U.S. Cl. CPC F16H 35/02
USPC 74/393

(57) ABSTRACT

A gear pair for a motor vehicle climate control system door drive mechanism includes a drive gear and a driven gear. The drive gear and the driven gear cooperate to form a gear pair, wherein the gear pair is constructed so that a gear ratio of the gear pair transitions from a linear gear ratio to a non-linear gear ratio. The non-linear gear ratio may be proportional to an exponential function. The gear pair is applied to linearly control a climate control door rotation speed when there is a need to meet temperature door linearity performance, and is applied to increase the climate control door rotation speed to meet total temperature door rotation time performance.

### CROSS REFERENCE TO RELATED APPLICATION

This application claims the benefit under 35 U.S.C. §119(e) of U.S. Provisional Patent Application No. 61/666,292, filed on Jun. 29, 2012, the content of which is incorporated by reference herein in its entirety.

### FIELD OF THE INVENTION

The present invention relates to a door drive mechanism of a climate control system for a vehicle, and more particularly, relates to a door drive mechanism of the climate control system that actuates doors for heating, ventilating, and air conditioning applications using a gear mechanism.

### BACKGROUND OF THE INVENTION

A motor vehicle typically includes a climate control system to maintain a temperature within a passenger compartment of the vehicle at a comfortable level by providing heating, cooling, and ventilation. Comfort can be maintained in the passenger compartment by an integrated system, referred to as a heating, ventilating, and air conditioning (HVAC) air-handling system. The HVAC air-handling system conditions air flowing therethrough and distributes the conditioned air throughout the passenger compartment.

The design of an HVAC air-handling system can include features that control air flow volume, air temperature, and one or more air flow paths, for example. Performance of the HVAC air-handling system may be designed to comply with particular targets including temperature linearity, wherein linearity is a predictable rate of change in temperature. For all operating states, it can be desirable to manipulate hot air streams and cold air streams to produce the proper temperatures and a predictable rate of change in temperature.

To comply with the desired linearity targets, HVAC air-handling systems can include features such as baffles, conduits, mixing plates, and/or climate control doors, or the like, to facilitate mixing of hot air streams with cold air streams. Undesirably, addition of these features and/or components can reduce airflow, degrade flow efficiency, increase noise, and increase the cost and weight of the system. Further issues can arise with a rate at which one or more ventilation conduits or climate control doors are opened and closed in the HVAC air-handling system. For example, mixing and delivery of air streams of various temperatures can be controlled by adjusting the rate at which a climate control door within a ventilation conduit is rotated throughout a range between a fully opened position and a fully closed position.

An issue with HVAC air-handling systems is that certain designs do not have the ability to rotate a climate control door at a rate of speed (deg/s) that is less than a rate of speed (deg/s) of a drive gear mechanism that is rotating a gear set attached to the climate control door without increasing the total time of rotation beyond a desired target. One way to address this issue is by using a linear pitch gear set with a constant gear ratio that reduces the rate of door rotation relative to the rate of actuator or motor rotation. While this method is effective, it requires additional actuator rotation and additional rotation time.

Another way to address this issue is by using a cam mechanism (kinematics) that involves a cam and pin interface that reduces the rate of door rotation relative to the rate of actuator or motor rotation. While this method is effective, it requires additional actuator rotation, additional rotation time, extra package space and, sometimes, extra components. Accordingly, improvements in ways to provide HVAC door rotation are desirable to optimize HVAC air-handing system operation.

### SUMMARY OF THE INVENTION

Concordant and consistent with the present invention, an improved mechanism for a climate control system door drive mechanism for a vehicle that minimizes actuator rotation and rotation times to optimize air-handling system operation has surprisingly been discovered.

According to the invention, a gear pair for a motor vehicle climate control system door drive mechanism includes a drive gear and a driven gear. The drive gear and the driven gear cooperate to form a gear pair, wherein the gear pair is constructed so that a gear ratio of the gear pair transitions from a linear gear ratio to a non-linear gear ratio. The non-linear gear ratio may be proportional to an exponential function. In one embodiment, the driven gear includes a first toothed portion having a substantially linear pitch radius and a second toothed portion having a pitch radius derived from an exponential function.

In another embodiment, a door drive mechanism for a vehicle climate control system includes an actuator rotatably coupled to an actuator gear about an actuator axis of rotation. The actuator gear includes a toothed portion having a first plurality of teeth. A door gear includes a toothed portion having a second plurality of teeth intermeshed with the first plurality of teeth, the door gear rotatably connected to a vehicle climate control door about a door axis of rotation to drive the door upon rotation of the actuator. A first portion of the first plurality of teeth is arranged having a first constant pitch radius from the actuator axis of rotation and a second portion of the first plurality of teeth is arranged having a first variable pitch radius from the actuator axis of rotation. The variable pitch radius may be non-linear, and may further be derived from an exponential function. Additionally, the variable pitch may include a first portion having a substantially linear pitch and a second portion having a substantially non-linear pitch.

The present invention therefore provides a climate control door drive mechanism that has the ability to slowly rotate climate control doors at a rate of speed necessary to meet design requirements while also providing the ability to still meet total rotation time requirements. As a result, a climate control door rotation speed may be linearly or non-linearly controlled when there is a need to meet temperature door linearity performance, and the climate control door rotation speed may also be increased to meet total temperature door rotation time performance.

### BRIEF DESCRIPTION OF THE DRAWINGS

The above, as well as other advantages of the present invention will become readily apparent to those skilled in the art from the following detailed description, particularly when considered in the light of the drawings described herein.

FIG. 1 is a perspective view of a prior art mechanism having a gear set with a constant linear pitch.

FIG. 2 is a perspective view of a prior art cam mechanism.

FIG. 3 is a perspective view of a non-linear, variable pitch gear set in a first door position according to an embodiment of the invention.

FIG. 4 is a perspective view of the non-liner, variable pitch gear set of FIG. 3 in a second door position according to an embodiment of the invention.

FIG. 5 is a graphical depiction of certain non-linear, variable pitch gear profiles according to an embodiment of the invention.

### DETAILED DESCRIPTION

The following detailed description and appended drawings describe and illustrate various embodiments of the invention. The description and drawings serve to enable one skilled in the art to make and use the invention, and are not intended to limit the scope of the invention in any manner.

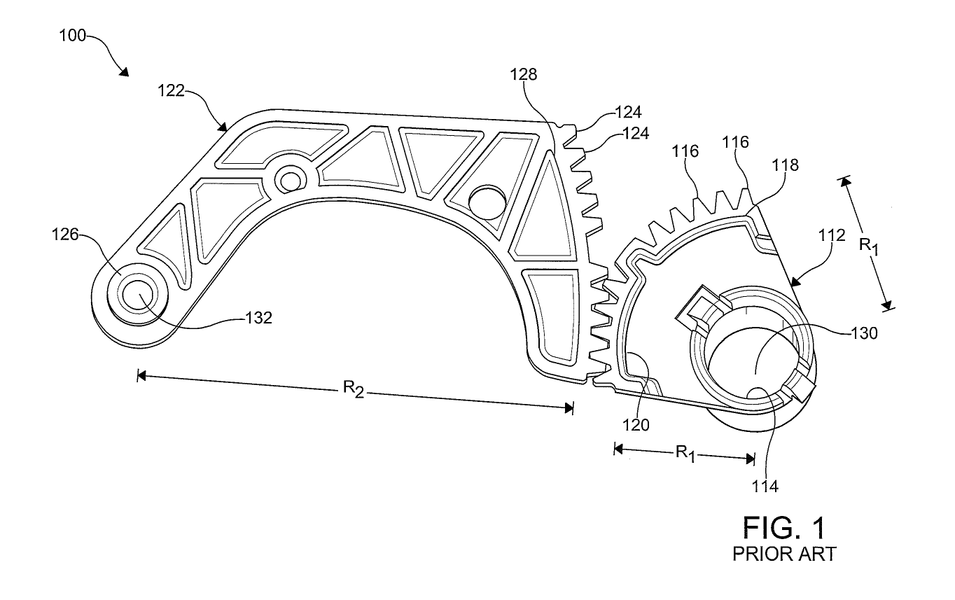

A prior art mechanism 100 using a linear pitch gear set having a constant gear ratio is shown with reference to FIG. 1. An actuator gear 112 includes an actuator gear hub 114 that is configured to receive an output shaft of an actuator mechanism (not shown). It is understood that the actuator mechanism may include a manually rotatable shaft, a motor, or other device having a rotational output. The actuator gear hub 114 is typically integrally attached to the actuator gear 112 so that a rotational force applied in the actuator gear hub 114 is translated directly to the actuator gear 112. The actuator gear 112 includes a plurality of teeth 116 located on a predetermined portion of the circumference 118. As shown in FIG. 1, the actuator gear 112 has a fan shape that has an arcuate outer peripheral part 120 corresponding to a portion of the circumference 118. A door gear 122 having a plurality of teeth 124 meshed with the plurality of teeth 116 of the actuator gear 112 is secured to a rotatable shaft 126. The rotatable shaft 126 is attached to a gear door (not shown) that rotates integrally with the rotatable shaft 126. The plurality of teeth 124 of the door gear 122 is included along an outer circumference 128 of the door gear 122. Additionally, as shown in FIG. 1, the outer circumference 128 of the door gear 122 may be less than 360 degrees.

The actuator gear hub 114 defines an axis of rotation 130 about which the actuator gear 112 rotates. The outer circumference 118 of the actuator gear 112 is a fixed distance, or constant radius, R₁ from the axis of rotation 130 of the actuator gear 112. The constant radius R₁ of the actuator gear 112 results in the actuator gear 112 having a fixed pitch radius from the axis of rotation 130.

Similarly, the rotatable shaft 126 of the door gear 122 defines an axis of rotation 132 about which the door gear 122 rotates. The outer circumference 128 of the door gear is a fixed distance, or constant radius, R₂ from the axis of rotation 132 of the door gear 122. The constant radius R₂ of the door gear 122 results in the door gear 122 having a fixed pitch radius from the axis of rotation 132.

As a non-limiting example, in one configuration the door gear 122 may have a constant radius R₂ equal to about 60 mm, while the actuator gear 112 may have a constant radius R₁ equal to about 20 mm. When intermeshed as shown in FIG. 1, the mechanism 100 develops a 3:1 gear ratio, meaning that for every 3 degrees of rotation of the actuator gear 112, the door gear 122 rotates 1 degree. Due to the fixed pitch radii of both the actuator gear 112 and the door gear 122, the rate of rotation by the door gear 122 is fixed in the 3:1 ratio. In this example, therefore, the actuator gear 112 must rotate 270 degrees to achieve a total rotation of 90 degrees by the door gear 122 (and by the gear door, not shown). The prior art design shown in FIG. 1 therefore provides for linear control of the gear door and the ability to rotate an air door at a rate of speed (deg/s) that is less than a rate of speed (deg/s) of an actuator, but only by adding considerable rotation distance and time to the mechanism 100.

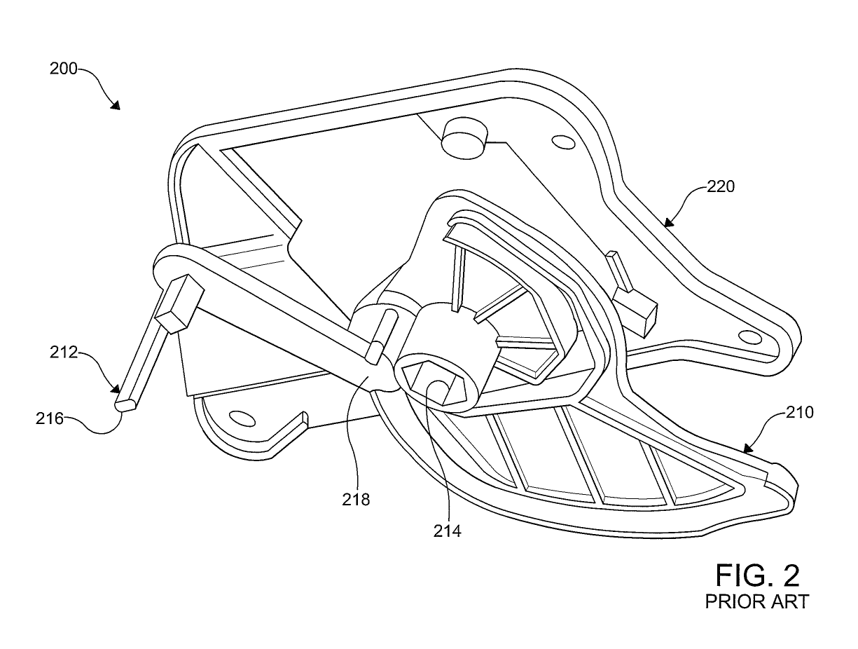

Another known mechanism that provides the ability to rotate an air door at a rate of speed less than a rate of speed of a drive gear mechanism attached to a rotating gear door without increasing the total time of rotation beyond a desired target is shown in FIG. 2. A cam drive mechanism 200 includes a cam 210 attached to a door lever 212. The cam 210 includes an actuator hub 214 integrally formed thereon that is configured to receive an output shaft of an actuator mechanism (not shown). It is understood that the actuator mechanism may include a manually rotatable shaft, a motor, or other device having a rotational output. The actuator hub 214 is typically integrally attached to the cam 210 so that rotational force applied in the actuator hub 214 is translated directly to the cam 210. The door lever 212 is attached to an air door (not shown) proximate a first end 216, while a second end 218 of the door lever 212 is coupled to the cam 210. A separate cam bracket 220 is used to mount the cam 210 to the actuator (not shown), and may further be useful to retain the cam 210 and the door lever 212 in proper alignment. As a non-limiting example, the cam 210 shown in FIG. 2 may be rotated by the actuator (not shown) through approximately 120 degrees of rotation, translating approximately 70 degrees of rotation to the air door (not shown) through the door lever 212. The cam mechanism 200 therefore is able to provide effective temperature linearity control, but it may require additional actuator rotation and additional rotation time. The cam mechanism 200 also requires the extra cam bracket 220, increasing the part count while adding weight, package volume, and cost.

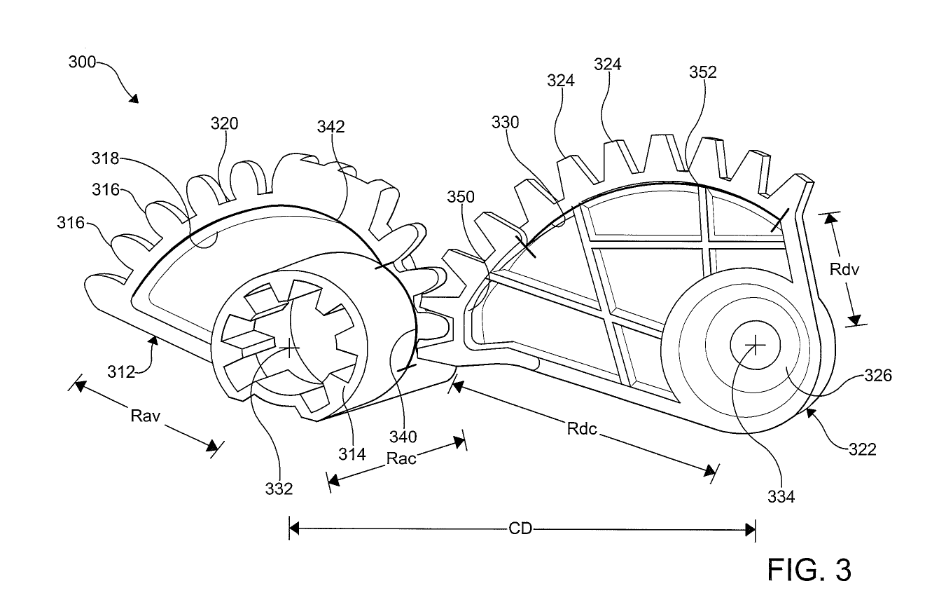

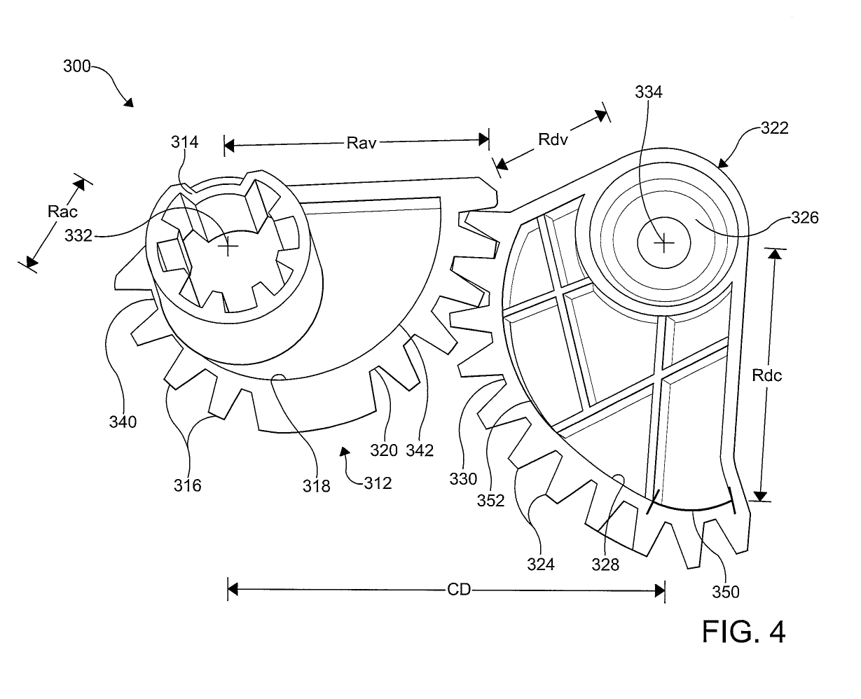

A door opening mechanism 300 is shown in FIGS. 3 and 4 that addresses the shortcomings of the prior art. In particular, FIG. 3 demonstrates the door opening mechanism 300 in a starting position, or a full hot door position, while FIG. 4 demonstrates the door opening mechanism 300 in an ending position, or a full cold door position. The door opening mechanism 300 includes an actuator gear 312 and a door gear 322. The actuator gear 312 includes an actuator gear hub 314 that is configured to receive an output shaft of an actuator mechanism (not shown). It is understood that the actuator mechanism may include a manually rotatable shaft, a motor, or other device having a rotational output. The actuator gear hub 314 is typically integrally attached to the actuator gear 312 so that a rotational force applied in the actuator gear hub 314 is translated directly to the actuator gear 312. The actuator gear 312 includes a plurality of teeth 316 located on a predetermined portion of the circumference 318 of the actuator gear 312. As shown in FIG. 3, the actuator gear 312 has a fan shape that has an arcuate outer peripheral part 320 corresponding to at least a portion of the circumference 318. It is understood that the actuator gear 312 may have any desired shape that presents the arcuate outer peripheral part 320.

The door gear 322 includes a plurality of teeth 324 meshed with the plurality of teeth 316 of the actuator gear 312 and is secured to a rotatable shaft 326. The rotatable shaft 326 is attached to a gear door (not shown) that rotates integrally with the rotatable shaft 326. The plurality of teeth 324 of the door gear 322 is included along an outer circumference 328 of the door gear 322. Additionally, as shown in FIGS. 3 and 4, the door gear 322 has a fan shape that has an arcuate outer peripheral part 330 corresponding to at least a portion of the circumference 328. The outer circumference 328 of the door gear 322 may be less than 360 degrees, and it is understood that the door gear 322 may have any desired shape that presents at least the arcuate outer peripheral part 330 that includes the plurality of teeth 324 intermeshed with the plurality of teeth 316 of the actuator gear 312.

The actuator gear 312 and the door gear 322 may be made from any suitable material, without limitation. Typically one gear material can be polyoxymethylene (POM) and the other gear material can be 40% mineral filled Nylon. However, it is understood that other materials and combinations of materials can be used.

The actuator gear hub 314 defines an axis of rotation 332 about which the actuator gear 312 rotates. Similarly, the rotatable shaft 326 of the door gear 322 defines an axis of rotation 334 about which the door gear 322 rotates. Further, the axis of rotation 332 of the actuator gear 312 is separated from the axis of rotation 334 of the door gear 322 by a fixed center-to-center distance CD. It is understood that the actuator gear 312 and the door gear 322 are sized and shaped so that the actuator gear 312 rotates about the axis of rotation 314 and the door gear 322 rotates about the axis of rotation 334 while maintaining intermeshing of the plurality of teeth 316 of the actuator gear 312 with the plurality of teeth 324 of the door gear 322, and while maintaining the fixed center-to-center distance CD.

The exemplary door opening mechanism 300 of FIGS. 3 and 4 may be distinguished from the prior art, however, by an ability to provide a non-linear predefined variable gear pitch in at least a portion of the gear pair travel. As non-limiting examples, the door opening mechanism 300 may provide a transition from a linear to a non-linear gear pitch near the start of gear travel. The door opening mechanism may also be configured to provide a transition from a non-linear gear pitch to a linear gear pitch near the start of gear travel. Also, the door opening mechanism may be configured to provide both transitions from linear to non-linear gear pitch and from non-linear to linear gear pitch at any point of the gear travel.

A variable gear pitch is provided in the door opening mechanism 300 by providing a predefined variable gear pitch for both the actuator gear 312 and the door gear 322. With reference to the actuator gear 312, the arcuate outer peripheral part 320 includes a first actuator gear arcuate portion 340 and a second actuator gear arcuate portion 342. In FIGS. 3 and 4, the first actuator gear arcuate portion 340 includes that portion of the arcuate outer peripheral part 320 closest to the axis of rotation 332 of the actuator gear hub 314 having a constant pitch radius R_{ac}, while the second actuator gear arcuate portion 342 includes that portion of the arcuate outer peripheral part 320 farthest away from the axis of rotation 332 of the actuator gear hub 314 having a variable pitch radius Rₐᵥ. It is understood, however, that other configurations of the arcuate outer peripheral part 320 may be used, as desirable. With reference to the door gear 322, the arcuate outer peripheral part 330 includes a first door gear arcuate portion 350 and a second door gear arcuate portion 352. In FIGS. 3 and 4, the first door gear arcuate portion 350 of the door gear 322 includes that portion of the arcuate outer peripheral part 330 farthest away from the axis of rotation 334 of the door gear 322 having a constant pitch radius R_{dc}, while the second door gear arcuate portion 352 of the door gear 322 includes that portion of the arcuate outer peripheral part 330 closest to the axis of rotation 334 of the door gear 322 having a variable pitch radius R_{dv}. It is understood, however, that other configurations of the arcuate outer peripheral part 330 may designed, as desirable

FIG. 3 shows the door opening mechanism in a starting position corresponding to a full hot mixing position of the gear door. The first actuator gear arcuate portion 340 of the actuator gear 312 having constant pitch radius R_{ac} corresponds to approximately the first 30 degrees of rotation by the actuator gear 312 in the clockwise direction. The first door gear arcuate portion 350 of the door gear 322 having a constant pitch radius R_{dc} corresponds to approximately the first 10 degrees of rotation by the door gear 322 in the counter-clockwise direction. It is understood that other degrees of rotation can be used as desired. As the actuator gear 312 rotates through the first actuator gear arcuate portion 340 that also corresponds to the first door gear arcuate portion 350, the door gear 322, fixed to the air door (not shown), rotates at a constant speed of 1 degree for every 3 degrees of rotation by the actuator gear 312, corresponding to a 1:3 gear ratio.

The second actuator gear arcuate portion 342 of the actuator gear 312 having variable pitch radius Rₐᵥ corresponds to approximately the next 130 degrees of rotation by the actuator gear 312 in the clockwise direction as shown in FIG. 3. The second door gear arcuate portion 352 of the door gear 322 having a variable pitch radius R_{dv} corresponds to approximately the next 80 degrees of rotation by the door gear 322 in the counter-clockwise direction. It is understood that other degrees of rotation can be used as desired. Thus, for the next 130 degrees of actuator gear rotation, the pitch between the two gears changes until the door rotates an additional 80° of rotation. In the embodiment shown in FIGS. 3 and 4, the variable pitch radius Rₐᵥ of the actuator gear 312 and the variable pitch radius R_{dv} of the door gear 322 change exponentially to achieve the example door gear movement.

Using the non-linear, variable pitch gear pair, for example, a user can operate a temperature control knob for an HVAC air-handling system that is coupled to the actuator gear. A rotation of the knob throughout a portion of a temperature range may provide a corresponding movement of the door gear, while rotation of the knob throughout another portion of the temperature range may provide an increase or decrease in the corresponding movement of the door gear.

The door opening mechanism 300 may include corresponding non-linear, variable pitch actuator gears 312 and door gears 322 (gear pairs) having a multitude of variable profiles. For example, Table 1 shows two exemplary gear profiles. According to Example 1, a first arcuate portion of the gear pair may include a constant 2(actuator):1(door) linear profile gear ratio in the direction rotating from full hot to full cold, a second arcuate portion of the gear pair may include a non-linear profile until the gear pitch reaches a 1.5:1 gear ratio, after which a third arcuate portion of the gear pair maintains the 1.5:1 linear profile gear ratio. The total amount of Example 1 temperature actuator rotation is approximately 155 degrees, while the total amount of door rotation is approximately 90 degrees.

According to the Example 2 of Table 1, a gear pair may be designed having a first arcuate portion with a constant 3(actuator):1(door) linear profile gear ratio in the direction rotating from full hot to full cold, and a second arcuate portion having a non-linear variable pitch gear profile until the end, at which the gear profile may specify, for example a 0.8:1 gear ratio. The total amount of the variant of Example 2 temperature actuator rotation is approximately 160 degrees. The total amount of door rotation is approximately 94 degrees.

TABLE 1
Pitch Definition

| Example | Start (FH) | Middle | End (FC) | reason |
|---|---|---|---|---|
| 1 | constant: 2:1 | variable | constant: 1.5:1 | Packaging and improve- |
| | | | | ment of temp. linearity |
| | | | | while maintaining the |
| | | | | rotation time require- |
| | | | | ment. |
| 2 | constant: 3:1 | variable | variable: 0.8:1 | Improvement of temp. |
| | | | | linearity while maintain- |
| | | | | ing the rotation |
| | | | | time requirement. |

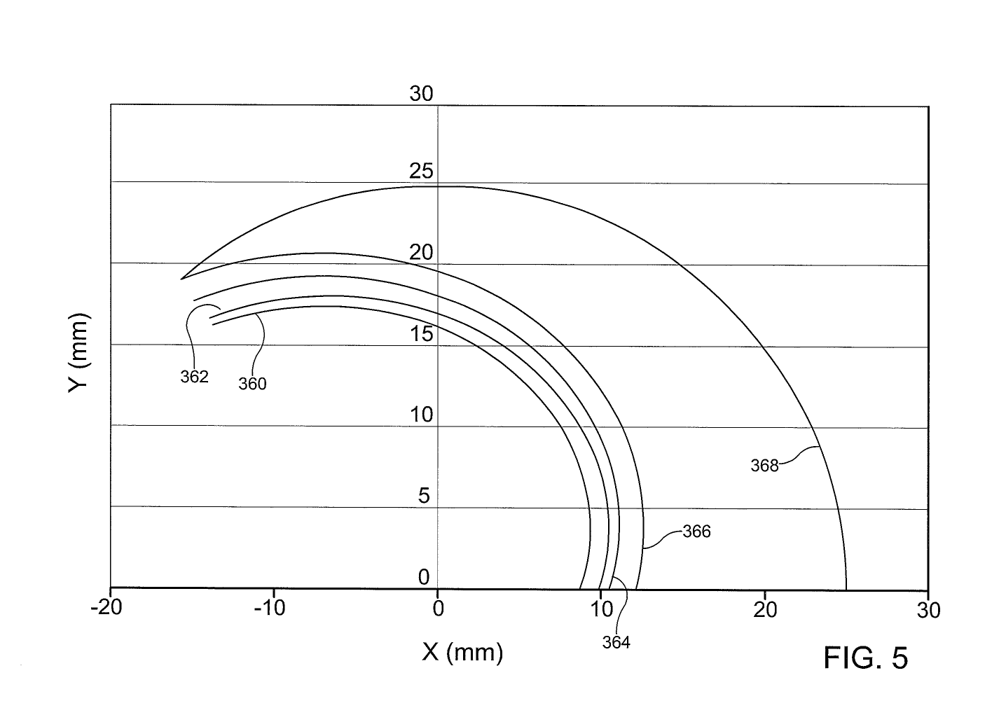

Several reference non-linear profiles for exemplary gear pairs are also shown graphically in FIG. 5. In particular, FIG. 5 shows a slope of the gear profile as the pitch radius changes from start to finish over 130° of rotation. The function that defines the slope in this case is an exponential function, but it is understood that any applicable function may be utilized to establish appropriate gear pair profiles. The curve 360 closest to the origin (X,Y of 0,0) in FIG. 5 shows a first minor exemplary profile. The second closest curve 362 to the origin shows a base exemplary profile. The third closest curve 364 to the origin shows an exemplary actuator pitch profile. The fourth closest curve 366 to the origin shows an exemplary major profile. The curve 368 furthest from the origin shows a reference circle.

According to one embodiment, the gear pitch radius curves in FIG. 5 may be derived using exponential functions. For example, the actuator gear variable pitch radius Rₐᵥ and rotation angle Θ may have the form of Equation 1:

Rₐᵥ=Ae^{kθ} Equation 1

where Rₐᵥ is the pitch radius of the actuator gear, θ is the angle of actuator rotation and A and k are chosen constants. Similarly, for a given center-to-center distance CD, a corresponding door gear variable pitch radius Rdv may have the form of Equation 2:

R_{dv}=CD−Rₐᵥ Equation 2

where R_{dv} is the pitch radius of the door gear. Equation 3 may then be used to determine a door gear rotation angle Ø, where:

Ø=1/k*In[(CD−Ae^{kΘ})/A] Equation 3

In Equations 1-3, CD, k, A and Θ are inputs and Rₐᵥ, R_{dv} and Ø are outputs.

According to the invention, the non-linear, variable pitch gear pair design can be used with climate control door drives in a motor vehicle air-handling system. Using this non-linear gear technology, it is possible to reduce the rate of speed of the climate control door rotation relative to the rate of speed of the actuator output shaft rotation in those locations where the climate control door is sensitive to temperature control curve linearity. Then, at other climate control door locations, where the climate control door position is less sensitive to temperature linearity, the rate of the climate control door rotational speed relative to that of the actuator output shaft speed can be increased to a speed that reduces a time necessary to completely rotate the door. Furthermore, by reducing the rate of speed of the door rotation at the sensitive end of rotation, it is possible to reduce the need for ventilation conduits or shades. The reduction in shade use can thereby increase the amount of cross section for airflow. Therefore, improved temperature linearity can be achieved with an increased cross section in airflow without increasing the time needed to rotate the door from one end of rotation to the other.

While certain representative embodiments and details have been shown for purposes of illustrating the invention, it will be apparent to those skilled in the art that various changes may be made without departing from the scope of the disclosure, which is further described in the following appended claims.

What is claimed is:

1. A door drive mechanism for a vehicle climate control system, comprising:
a drive gear and a driven gear cooperating to form a gear pair, wherein a gear ratio of the gear pair transitions from a linear gear ratio to a non-linear gear ratio.

2. The door drive mechanism for a vehicle climate control system of claim 1, wherein the non-linear gear ratio is derived from an exponential function.

3. The door drive mechanism for a vehicle climate control system of claim 1, wherein the drive gear and the driven gear have a constant pitch radius to generate the linear gear ratio.

4. The door drive mechanism for a vehicle climate control system of claim 1, wherein the drive gear and the driven gear have a variable pitch radius to generate the non-linear gear ratio.

5. The door drive mechanism for a vehicle climate control system of claim 1, wherein a first portion of the drive gear includes a substantially constant pitch radius and a second portion of the drive gear includes a variable pitch radius.

6. The door drive mechanism for a vehicle climate control system of claim 5, wherein a third portion of the drive gear includes one of a second constant pitch radius and a second variable pitch radius.

7. The door drive mechanism for a vehicle climate control system of claim 5, wherein the variable pitch radius is derived using the function:
R=Ae^{kΘ}
where R is the variable pitch radius, Θ is the angle of actuator rotation and A and k are chosen constants.

8. A door drive mechanism for a vehicle climate control system, comprising:
an actuator gear having an actuator axis of rotation, the actuator gear including a toothed portion having a first plurality of teeth;
a door gear including a toothed portion having a second plurality of teeth intermeshed with the first plurality of teeth, the door gear configured to be rotatably connected to a vehicle climate control door about a door axis of rotation to drive the door upon rotation of the actuator gear, wherein a first portion of the first plurality of teeth is arranged having a first constant pitch radius from the actuator axis of rotation and a second portion of the first plurality of teeth is arranged having a first variable pitch radius from the actuator axis of rotation.

9. The door drive mechanism for a vehicle climate control system of claim 8, wherein a first portion of the second plurality of teeth is arranged having a second constant pitch radius from the door axis of rotation and a second portion of the second plurality of teeth is arranged having a second variable pitch radius from the door axis of rotation.

10. The door drive mechanism for a vehicle climate control system of claim 8, wherein a center to center distance between the actuator axis of rotation and the door axis of rotation is a fixed distance.

11. The door drive mechanism for a vehicle climate control system of claim 8, wherein the first variable pitch radius is derived from an exponential function.

12. The door drive mechanism for a vehicle climate control system of claim 8, wherein the first variable pitch radius is derived using the function:
Rₐᵥ=Ae^{kΘ}
where Rₐᵥ is the first variable pitch radius, Θ is the angle of actuator rotation and A and k are chosen constants.

13. The door drive mechanism for a vehicle climate control system of claim 8, wherein a third portion of the first plurality of teeth is arranged having one of a third constant pitch radius and a third variable pitch radius.

14. A door drive mechanism for a vehicle climate control system, comprising:
an actuator gear having an actuator axis of rotation, the actuator gear including a first arcuate toothed portion, a first plurality of gear teeth formed in the first arcuate toothed portion;
a door gear including a second arcuate toothed portion, a second plurality of teeth formed in the second arcuate toothed portion and intermeshed with the first plurality of teeth, the door gear configured to be rotatably connected to a vehicle climate control door about a door axis of rotation to drive the door upon rotation of the actuator gear, wherein a first portion of the first arcuate toothed portion of the actuator gear is arranged having a first constant pitch radius from the actuator axis of rotation and a second portion of the first arcuate toothed portion of the actuator gear is arranged having a first variable pitch radius from the actuator axis of rotation.

15. The door drive mechanism for a vehicle climate control system of claim 14, wherein a first portion of the second arcuate toothed portion of the door gear is arranged at a second constant pitch radius from the door axis of rotation and a second portion of the second arcuate toothed portion of the door gear is arranged at a second variable pitch radius from the door axis of rotation.

16. The door drive mechanism for a vehicle climate control system of claim 15, wherein the first variable pitch is derived from an exponential function.

17. The door drive mechanism for a vehicle climate control system of claim 16, wherein the first variable pitch radius is derived using the function:
Rₐᵥ=Ae^{kΘ}
where Rₐᵥ is the first variable pitch radius, Θ is the angle of actuator rotation and A and k are chosen constants.

18. The door drive mechanism for a vehicle climate control system of claim 16, wherein a center to center distance between the actuator axis of rotation and the door axis of rotation is a fixed distance.

19. The door drive mechanism for a vehicle climate control system of claim 18, wherein the second variable pitch radius is derived using the function:
R_{dv}=CD−Rₐᵥ
where R_{dv} is the second variable pitch radius, and CD is the center to center distance between the actuator axis of rotation and the door axis of rotation.

20. The door drive mechanism for a vehicle climate control system of claim 18, wherein a third portion of the first arcuate toothed portion of the actuator gear is arranged having one of a third constant pitch radius and a third variable pitch radius.
